(19) United States
(12) Patent Application Publication
(10) Pub. No.: US 2008/0070606 A1
(43) Pub. Date: Mar. 20, 2008

(54) Apparatus, method, system and software product involving a macrodiversity arrangement for a multicast service on a high speed transport channel

(76) Inventors: Kari Rikkinen, Ii (FI); Jorma Kaikkonen, Oulu (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(21) Appl. No.: 11/825,119

(22) Filed: Jul. 2, 2007

Related U.S. Application Data
(60) Provisional application No. 60/818,230, filed on Jun. 30, 2006.

(51) Int. Cl. H04Q 7/20

(52) U.S. Cl. 455/466

(57) ABSTRACT

An apparatus, method, system and software product are for receiving a broadcast service or a multicast service. User equipment receives information about transmissions of data for a broadcast or multicast. The data is transmitted in non-overlapping signals from a plurality of cells. The user equipment then uses this information to attempt to decode at least one of the signals, if decoding another of the signals failed.

### CROSS-REFERENCE TO RELATED APPLICATION

This application claims priority to U.S. Provisional Application No. 60/818,230 filed Jun. 30, 2006.

### BACKGROUND OF THE INVENTION

1. Technical Field

The present invention pertains to the field of telecommunications. More particularly, the present invention pertains to a multicast service on a transport channel.

2. Discussion of Related Art

High-Speed Downlink Packet Access (HSDPA) is a mobile telephony protocol and is sometimes referred to as a 3.5G (or “3½G”) technology. In this respect it extends Wideband Code Division Multiple Access (WCDMA). HSDPA provides a smooth evolutionary path for Universal Mobile Telecommunications System (UMTS) networks allowing for higher data capacity (up to 14.4 Mbit/s in the downlink). It is an evolution of the WCDMA standard, designed to increase the available data rate by a factor of 5 or more. HSDPA defines a new WCDMA channel, the high-speed downlink shared channel (HS-DSCH) that operates in a different way from existing WCDMA channels, but is only used for downlink communication to the mobile.

HSDPA signal usage for point-to-multipoint (p-t-m) Multimedia Broadcast Multicast Service (MBMS) connections is a relatively new topic that has not been included in 3GPP specifications by Release 6. Release 6 of the Third Generation Partnership Project (3GPP) described various features of a Multimedia Broadcast Multicast Service (MBMS). The technical report 3GPP TR 25.992, “Multimedia Broadcast/Multicast Service (MBMS); UTRAN/GERAN requirements, Version 6.0.0 (2003-09)” is incorporated by reference herein, and describes an MBMS (Broadcast/Multicast) Session as a continuous and time-bounded reception of a broadcast/multicast service by the UE. A single broadcast/multicast service can only have one broadcast/multicast session at any time, but may consist of multiple successive broadcast/multicast sessions. MBMS includes both a broadcast mode, which is the part of MBMS that supports broadcast services, as well as a multicast mode, which is the part of MBMS that supports multicast services. Quality of service attributes are the same for MBMS Multicast and Broadcast modes.

Technical Report 25.992 additionally explains that MBMS data transfer occurs in the downlink only. During this MBMS data transmission, paging messages can be received. However, simultaneous reception of MBMS and non-MBMS services depend upon UE capabilities, and likewise simultaneous reception of more than one MBMS services also depends upon UE capabilities. A notification procedure is used to indicate the start of MBMS data transmission. Mechanisms are required to enable the Network to move MBMS subscribers between cells, and to enable the non-transmission of MBMS multicast mode in a cell which does not contain any MBMS UEs joined to the multicast group. MBMS does not support individual retransmissions at the radio link layer, nor does it support retransmissions based on feedback from individual subscribers at the radio level. However, this does not preclude the periodic repetitions of the MBMS content based on operator or content provider scheduling or retransmissions based on feedback at the application level. MBMS Multicast mode transmissions should use dedicated resources (p-t-p) or common resources (p-t-m), and the selection of the connection type (p-t-p or p-t-m) is operator-dependent, typically based on the downlink radio resource environment such as radio resource efficiency; a “threshold” related to the number of users may be utilized, resulting in the need for a mechanism to identify the number of subscribers in a given area.

According to Release 6, the MBMS is specified at the physical layer level in the following way, depending upon the number of users. For point-to-multipoint (p-t-m) transmission, the MBMS uses a Forward Access Transport Channel (FACH) mapped onto a Secondary Common Control Physical Channel (S-CCPCH). For point-to-point (p-t-p) transmission, the MBMS uses a Dedicated Transport Channel (DCH) mapped to a Dedicated Physical Data Channel (DPDCH).

Reliable detection of an HSDPA MBMS signal may be difficult for MBMS user equipment (UE), especially if the UE is located close to cell borders. Unfortunately, according to the present technology, a UE close to the cell border will only be able to detect and MBMS transmission from a single cell.

### DISCLOSURE OF THE INVENTION

Assuming that the same MBMS content is transmitted in adjacent cells, it is beneficial to adjust the MBMS signal transmissions so that MBMS UEs can try to detect the MBMS signal from all neighboring cells before requesting retransmissions, in the event that there is failure to detect an MBMS signal.

Simultaneous transmission of MBMS signals from adjacent cells could bring some additional complexity to a UE receiver, since the receiver would need to reserve resources for transmissions from all adjacent cells. Furthermore, accurate transmission timing between neighboring cells could also bring some complexity at the network side. However, improved MBMS reception may be well worth such costs.

The present invention is related to the 3.5G WCDMA evolution beyond Release 7. This invention gives a solution to carry out MBMS services via HSDPA in a spectrum-efficient way. According to an embodiment of the present invention, the same MBMS content (e.g. MBMS MAC-layer protocol data unit PDU) is transmitted on the High-Speed Downlink Shared Transport Channel (HS-DSCH) in different time instants in adjacent cells to enable dynamic joint macrodiversity combining.

### BRIEF DESCRIPTION OF THE DRAWINGS

FIG. 1 presents relative timing of HSDPA MBMS signals from adjacent cells.

FIG. 2 presents how a HSDPA MBMS user equipment located close to a cell border could communicate between adjacent cells.

FIG. 3 is a flow chart of an embodiment of the present invention.

FIG. 4 is a block diagram of a mobile terminal according to an embodiment of the present invention.

### BEST MODE FOR CARRYING OUT THE INVENTION

An embodiment of the present invention will now be detailed with the aid of the accompanying figures. It is to be understood that this embodiment is merely an illustration of one particular implementation of the invention, without in any way foreclosing other embodiments and implementations.

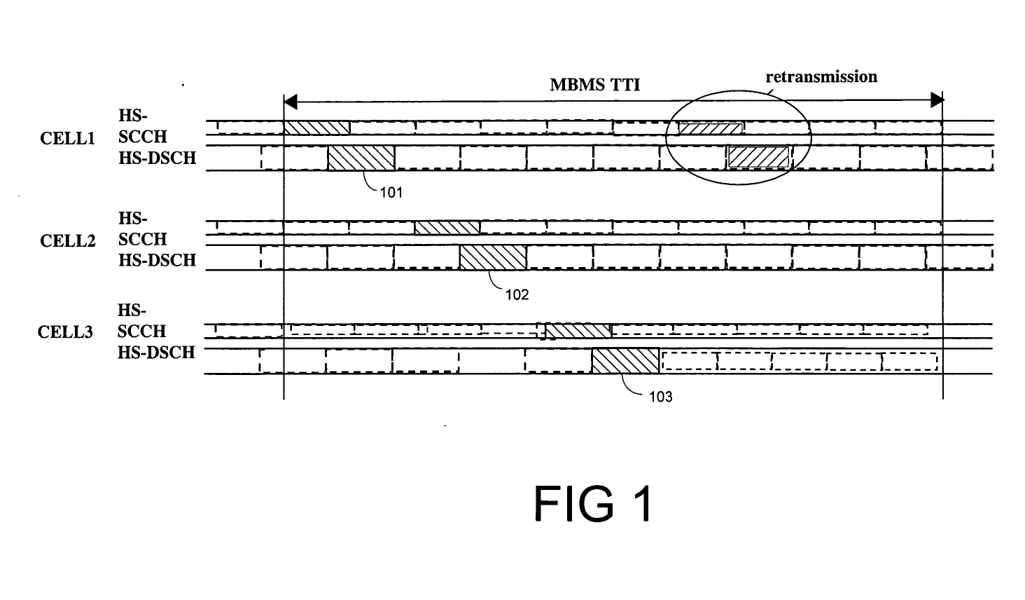

It is desired that the same MBMS content (e.g. MBMS MAC-layer protocol data unit PDU) be transmitted on the High-Speed Downlink Shared Transport Channel (HS-DSCH). Therefore, this embodiment of the invention calls for neighboring cells to adjust transmission timing of the same MBMS data block, so that they are not overlapping in time. In the example case shown in FIG. 1, there are three cells sending the same MBMS signal over a transmission time interval (TTI), and the first cell sends one retransmission during the same transmission time interval. Notice that the transmissions 101, 102, and 103 do not overlap in the time domain.

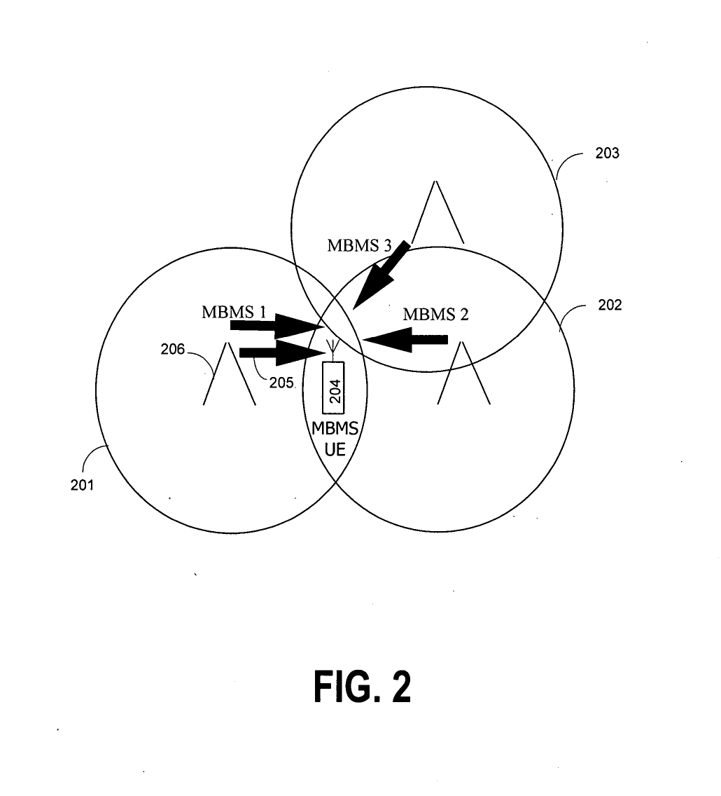

One of the cells is defined as a “primary cell” for each MBMS UE. The other cells in the UE's MBMS cell-list are defined as “neighboring cells.” As shown in FIG. 2, cell 201 is a primary cell, cell 202 is a neighboring cell, and cell 203 is also a neighboring cell. The primary cell has knowledge about MBMS transmission timing in the adjacent neighboring cells. Accordingly, the primary cell informs the UE 204, via an information signal 205 such as a corresponding MBMS UE identification (ID), what the UE needs to decode from a High Speed Shared Control Channels (HS-SCCHs) in order to obtain an indication of an incoming MBMS data block. Additionally, the primary cell's node B (i.e. base station 206) can inform the UE about the “time window,” compared to the serving cell timing where they can expect to receive MBMS data from adjacent cells.

Each MBMS UE tries to decode the MBMS signal first from one of the cells in the cell-list; this could be the primary cell, or alternatively it could be the first available cell in the time domain. If this decoding attempt succeeds, then the UE continues to monitor the current cell for the next MBMS data block. Alternatively, if the transmission window for the next MBMS data block is known in advance, the UE could “sleep” until the next MBMS data block is expected to arrive.

If the attempt to decode the MBMS signal fails, the UE jumps to monitor the signal from the next suitable cell (according to the MBMS cell-list or observed quality) for another opportunity to attempt decoding the MBMS signal. If the attempt fails again, then the UE jumps to monitor and decode the next suitable cell in the cell-list until the UE succeeds in decoding, or all suitable cells in the list have been tried out. If the attempt to decode the MBMS signal fails after all suitable cells in the cell-list have been tried out, the UE may send a retransmission request to the primary cell.

Cells which are monitored, or for which a decoding attempt is made, could alternatively be selected autonomously by the UE from the given/signaled monitored cell set based on the suitability of the timing and/or observed quality. Transmissions from different cells can be combined by the UE either by using selective, soft, or Hybrid Automatic Repeat Request (HARQ) combining. In case of HARQ combining, the transmission timing may need to account for the processing delays associated with HARQ processes.

The solution described by this embodiment of the present invention allows a simple UE (e.g. having a 1Rx antenna) to utilize macrodiversity for HSDPA MBMS connections. This produces improved HSDPA MBMS performance with 1Rx HSDPA (MBMS) UEs.

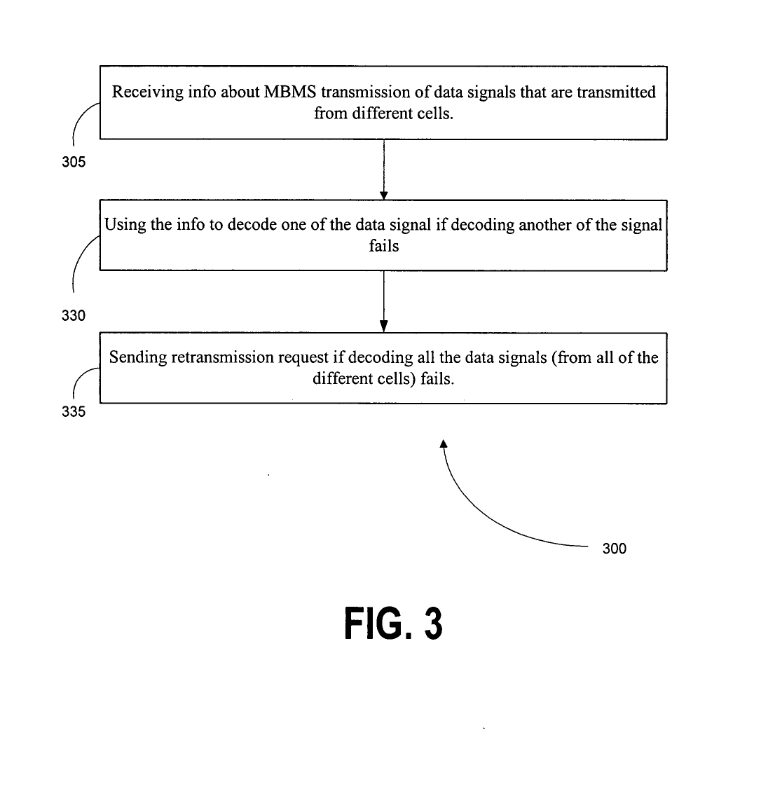

Turning now to FIG. 3, an embodiment of the method 300 of the present invention is shown using a flow chart. Information is received 305 regarding MBMS transmission of data signals that are transmitted from different cells or base stations. That information is then used 330 to decode one of the data signals if decoding another of the data signals fails. This process repeats until a decoding is successful, or until it has completely failed. If decoding all the data signals (from all of the available cells) fails, then a retransmission request is sent 335.

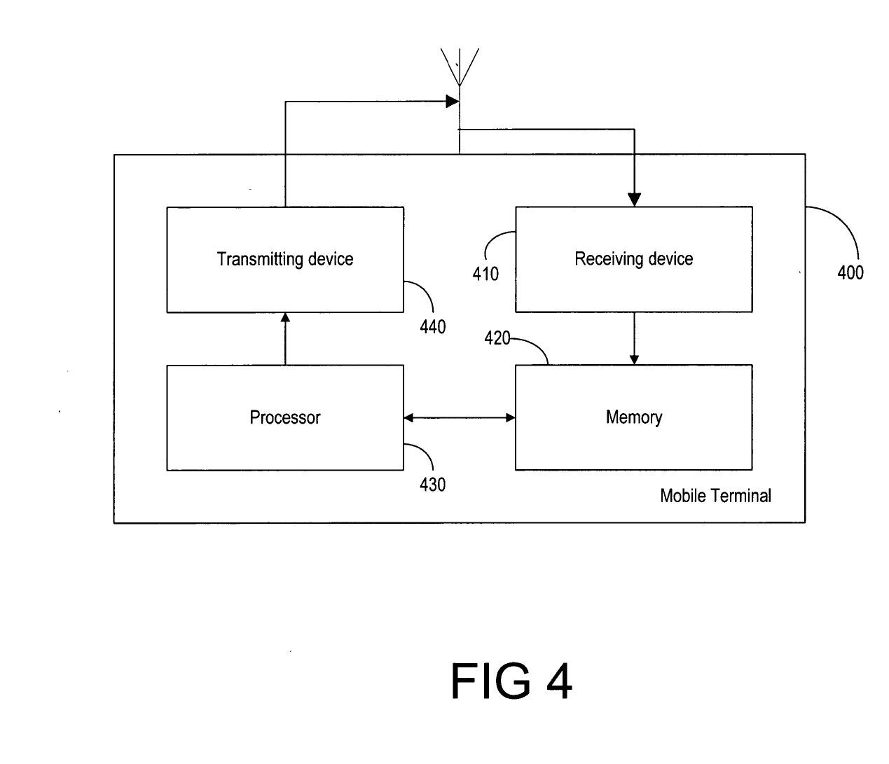

FIG. 4 shows user equipment (i.e. a mobile terminal) 400 for implementing this embodiment of the invention. The apparatus 400 includes a receiving device 410 configured to receive information via an antenna, and this information provides details about transmissions of data for a broadcast or multicast. The transmitted data is contained in non-overlapping signals from a plurality of different cells. The information about the transmissions is stored in a memory unit 420.

The apparatus 400 also includes a processor 430 configured to use the information stored in the memory unit 420 in order to attempt decoding at least one of the non-overlapping signals, if decoding another of the signals failed. These decoding attempts entail further use of the receiving device 410. Additionally, the apparatus further includes a transmitting device 440 configured to send a retransmission request via the antenna, if decoding all of the signals has failed.

The present invention also includes a software product for performing the embodiment of the method described above, and the software can be implemented using a general purpose or specific-use computer system, with standard operating system software conforming to the method described herein. The software is designed to drive the operation of the particular hardware of the system, and will be compatible with other system components and I/O controllers. The computer system of this embodiment includes a CPU processor such as the processor 430 shown in FIG. 4, comprising a single processing unit, multiple processing units capable of parallel operation, or the CPU can be distributed across one or more processing units in one or more locations, e.g., on a client and server, or within other components. The memory 420 may comprise any known type of data storage and/or transmission media, including magnetic media, optical media, random access memory (RAM), read-only memory (ROM), a data cache, a data object, or the like. Moreover, similarly to the CPU, the memory may reside at a single physical location, comprising one or more types of data storage, or be distributed across a plurality of physical systems in various forms.

It is to be understood that all of the present figures, and the accompanying narrative discussions of corresponding embodiments, do not purport to be completely rigorous treatments of the method, apparatus, system, and software product under consideration. A person skilled in the art will understand that the steps and signals of the present application represent general cause-and-effect relationships that do not exclude intermediate interactions of various types, and will further understand that the various steps and structures described in this application can be implemented by a variety of different sequences and configurations, using various combinations of hardware and software which need not be further detailed herein.

What is claimed is:

1. A method, comprising:
receiving information about transmissions of data for a broadcast or multicast, wherein the data is transmitted in non-overlapping signals from a plurality of cells or base stations; and
using the information to attempt to decode at least one of the signals if decoding another of the signals failed.

2. The method of claim 1, further comprising sending a retransmission request if decoding all of the signals has failed.

3. The method of claim 1, wherein the information is from a primary cell, and the retransmission request is directed to the primary cell.

4. The method of claim 1, wherein said signals are transmitted on a high-speed downlink shared channel.

5. The method of claim 1, wherein the plurality of cells or base stations are adjacent.

6. The method of claim 1, wherein a dynamic joint macrodiversity combining and retransmission procedure is enabled.

7. An apparatus comprising:
means for receiving information about transmissions of data for a broadcast or multicast, wherein the data is contained in non-overlapping signals from a plurality of cells or base stations; and
means for using the information to attempt to decode at least one of the signals if decoding another of the signals failed.

8. The apparatus of claim 7, further comprising means for sending a retransmission request if decoding all of the signals has failed.

9. The apparatus of claim 7, wherein the information is from a primary cell, and the retransmission request is directed to the primary cell.

10. The apparatus of claim 7, wherein said signals are transmitted on a high-speed downlink shared channel.

11. The apparatus of claim 7, wherein the plurality of cells or base stations are adjacent.

12. The apparatus of claim 7, wherein a dynamic joint macrodiversity combining and retransmission procedure is enabled.

13. An apparatus comprising:
a receiving device configured to receive information about transmissions of data for a broadcast or multicast, wherein the data is contained in non-overlapping signals from a plurality of cells or base stations; and
a processor configured to use the information in order to attempt decoding at least one of the signals if decoding another of the signals failed.

14. The apparatus of claim 13, further comprising a transmitting device configured to send a retransmission request if decoding all of the signals has failed.

15. The apparatus of claim 13, wherein the information is from a primary cell, and the retransmission request is directed to the primary cell.

16. The apparatus of claim 13, wherein said signals are transmitted on a high-speed downlink shared channel.

17. The apparatus of claim 13, wherein the plurality of cells or base stations are adjacent.

18. The apparatus of claim 13, wherein a dynamic joint macrodiversity combining and retransmission procedure is enabled.

19. A computer program product including a computer-readable medium having computer-executable components comprising:
a component for receiving information about transmissions of data for a broadcast or multicast, wherein the data is transmitted in non-overlapping signals from a plurality of cells or base stations; and
a component for using the information to attempt to decode at least one of the signals if decoding another of the signals failed.

20. The computer program product of claim 19, further comprising a component for sending a retransmission request if decoding all of the signals has failed.

21. A network element, comprising:
an informing module, configured to provide information about transmissions of data for a broadcast or multicast, wherein the data is transmitted in non-overlapping signals from a plurality of cells or base stations; and
a data transmission module configured to transmit the data in at least one of the non-overlapping signals.

22. The network element of claim 21, further comprising a retransmission module configured to provide a retransmission in response to a notification that decoding all of the non-overlapping signals has failed.

23. A system comprising:
a plurality of cells or base stations configured to transmit data for a broadcast or multicast, in non-overlapping signals, wherein at least one of the cells or base stations is also configured to provide information about the non-overlapping signals;
a user equipment configured to receive the information and use the information to attempt to decode at least one of the non-overlapping signals if decoding another of the non-overlapping signals failed.

24. The system of claim 23, wherein the at least one of the cells or base stations is further configured to retransmit at least part of the broadcast or multicast in response to a notification from the user equipment that decoding all of the non-overlapping signals has failed.
